(19) United States
(12) Patent Application Publication
(10) Pub. No.: US 2009/0075531 A1
(43) Pub. Date: Mar. 19, 2009

(54) Electrical connector with improved contact

(75) Inventor: Shu Zhong, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/284,297

(22) Filed: Sep. 18, 2008

(30) Foreign Application Priority Data
Sep. 18, 2007 (CN) 200720046655.8

(51) Int. Cl. H01R 13/15

(52) U.S. Cl. 439/839

(57) ABSTRACT

An electrical connector includes an insulating housing having a longitudinal and a lateral wall defining a top face and at least one contact. The lateral wall defines a slot thereon. The contact includes a main body located one the top face of the lateral wall and a contacting arm located above the longitudinal wall, a connecting portion extending from an inner edge of the main body and a retaining portion extending from an outer edge of the main body. The retaining portion is retained and received in the slot. A pressed portion laterally extends from the main body.

### BACKGROUND OF THE INVENTION

1. Field of the invention

The present invention relates to an electrical connector with contacts on a top surface of an insulating housing.

2. Description of Related Art

As FIG. 1 shown, a conventional electrical connector includes an insulating housing 1′ and two contacts 2′. The housing is a rectangular frame. The contact in an L-like shape includes a main body 21′ located on a top face of a lateral sidewall of the housing after the contact is assembled on the housing in a top to down direction, wherein two retaining portion 26′ extending from an outer edge of the main body is inserted into and retained in corresponding slots 10′ defined in the lateral sidewall. The retaining portion bents from the main body by a curved transition portion 25′. A resilient contacting portion 22′ is perpendicular to the main body and upwardly-slantwise located above a longitudinal sidewall to mating with a speaker component. An abutting portion 23′ on another end of the main body opposite to the contacting portion abuts against the stop face 11′ on another longitudinal sidewall, thereby the contacts is stopped in the longitudinal direction. A soldering portion 24′ adjacent to the contacting portion extends downwards from the main body. The contacts are assembled to the housing by an automatic machine.

Due to continuing trend toward miniaturization and improved performance by the electronics industry, the housing and the contact become smaller. However, accurate position of the contacts to the slots and the automatic machine to the contact is difficult when assembling of the contacts, thereby forming a loose assembly of the contact and the housing.

Therefore, an improved electrical connector is desired to overcome the disadvantages of the prior arts.

### SUMMARY OF THE INVENTION

An object of the present invention is to provide an electrical connector with a contact, the contact is easily and fitly assembled in an insulating housing of the electrical connector.

In order to achieve above-mentioned object, an electrical connector comprises an insulating housing comprising a longitudinal and a lateral wall defining a top face and at least one contact. The lateral wall defines a slot thereon. The contact comprises a main body located one the top face of the lateral wall and a contacting arm located above the longitudinal wall, a connecting portion extending from an inner edge of the main body and a retaining portion extending from an outer edge of the main body. The retaining portion is retained and received in the slot. A pressed portion laterally extends from the main body.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is an exploded view of a conventional electrical connector;

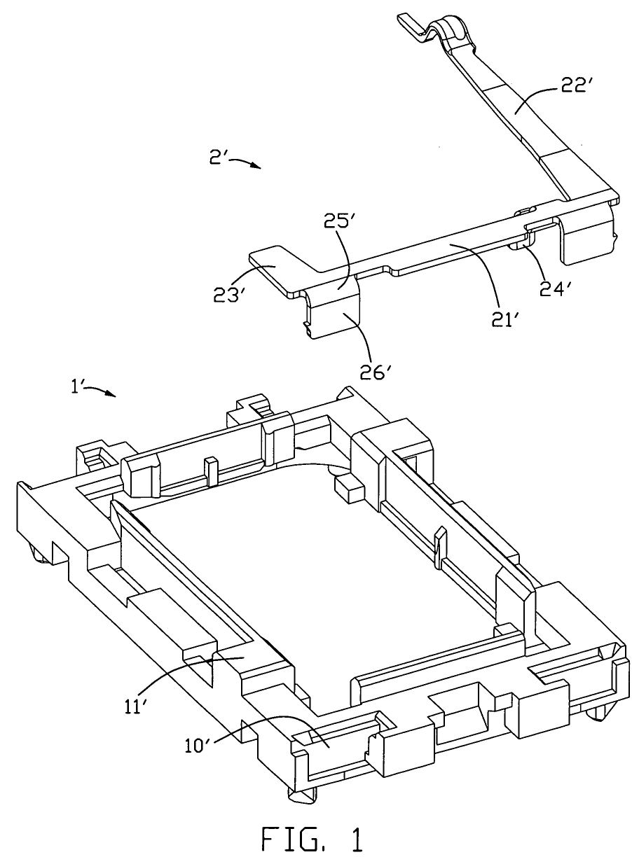

FIG. 2 is an exploded view of an electrical connector embodying the present invention;

FIG. 3 is a detailed view of an enlarged portion of FIG. 1 by the dashed box; and

FIG. 4 is an exploded view of an electrical connector of FIG. 2.

### DETAILED DESCRIPTION OF THE INVENTION

Reference will now be made to the drawing figures to describe a preferred embodiment of the present invention in detail.

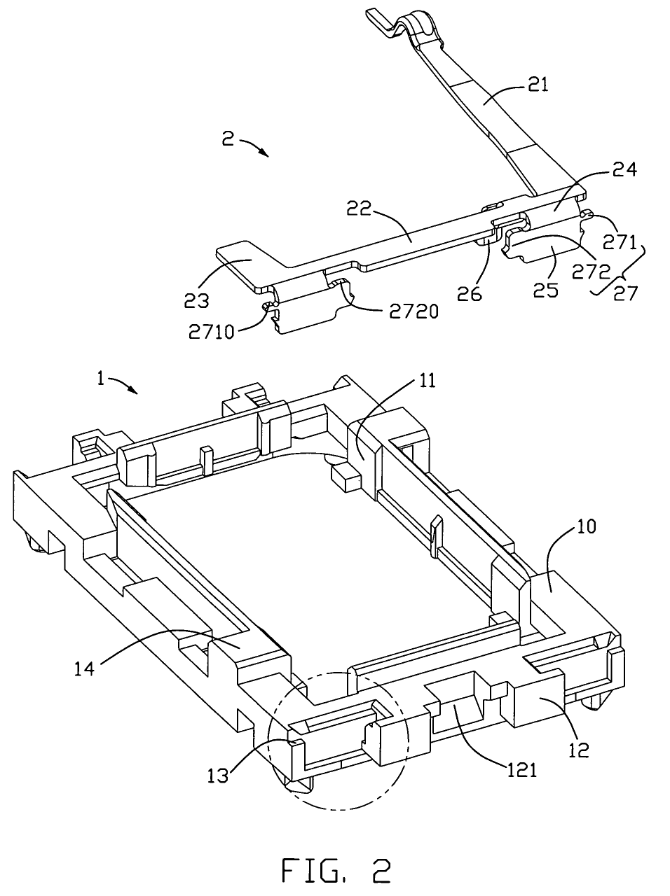

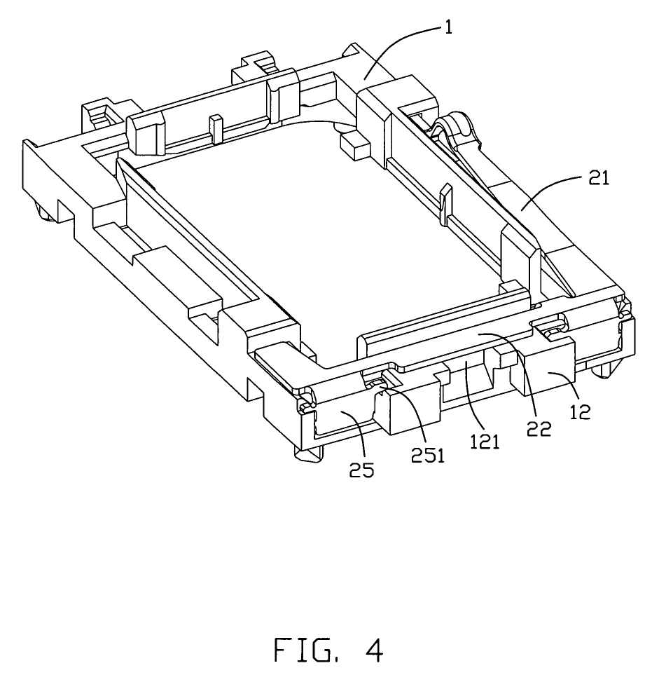

Referring to FIGS. 2 and 4, an electrical connector embodying the present invention includes an insulating housing 1 and two contacts 2 (only one is shown in the figures and the two contacts are symmetrical). The housing is a rectangular frame with two parallel longitudinal walls 11 and two lateral walls 12 each having a top face 10. The contact 2 in an L-like shape includes a main body 22 located on a top face 10 of the lateral sidewall 12 of the housing after the contact 2 is assembled on the housing in a top-to-down direction. A cantilevered resilient contacting arm 21 extending perpendicular from one end of the main body 21, is located above the top face of the longitudinal wall 11 of the housing in an free end upward slant pattern. An abutting portion 23 extending from another end opposite to said one end of the main body 21, is located on the top face of another longitudinal wall. The abutting portion 23 abuts against a step portion 14 integrally defined on the longitudinal wall 12, which will further stop the contact from forward moving along the longitudinal wall. Two retaining portion 25 adjacent two ends of the main body 21 and bending from opposite edges opposite to where the contacting arm 21 extending, are retained in two corresponding slots 13 defined in the lateral wall 12. The retaining portion 25 is mechanically connecting with the main body by a curved transition portion 24. A connecting portion 26 extends downward from the inner edge of the main body for being soldered with a electronic wire.

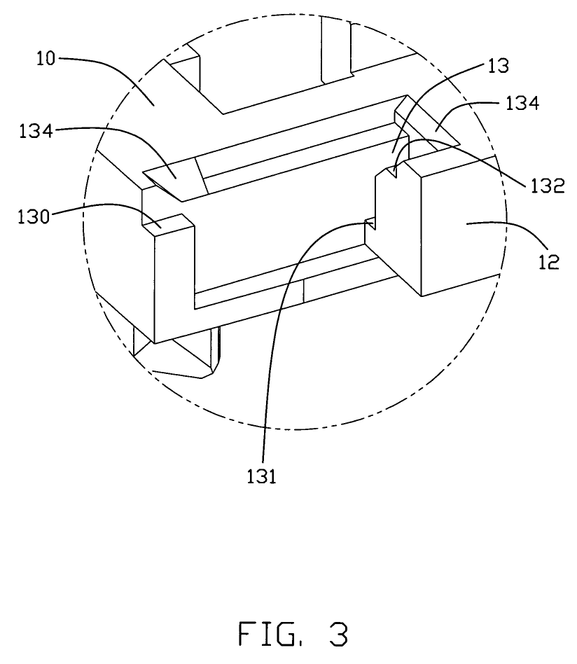

As best shown in FIG. 3, the slot 13 opens upward and outwards to communicate an exterior. One inner face adjacent to one end of the slot defines step portions forming a lower face 131 and an upper face 132 both facing upwardly. Another end defines a top face 130. Two downward slant guiding faces 134 are formed in an inner side of the slot from the top face 10 of the housing. Referring to FIG. 2, a first pressed portion 271 parallel projects outward from an outer lateral edge of the retaining portion 25 and a second pressed portion 272 parallel projects outward from an inner lateral edge of the retaining portion 25, two adjacent second pressed portions 272 facing to each other. The tops of the two pressed portions are on a same lever while the bottom of the first pressed portion is higher than the second portion, in other word, the second portion is wider than the first pressed portion.

During assembly the contact 2 to the slot 13, the automotive machine clip the pressed portion 27 including the first and second pressed portions 271, 272 to the slot 13, and then press against the top faces 2710, 2720 of pressed portions while a supporting tool goes through a passageway 121 defined in the middle of the lateral wall to upwards support on the main body of the contact, thereby retaining the contact in the slot 13. The second pressed portion 272 abuts against the lower face 131 and the first pressed portion 271 abuts against the top face 130. The upper face 132 leaves a predetermined room for the automotive machine.

However, the disclosure is illustrative only, changes may be made in detail, especially in matter of shape, size, and arrangement of parts within the principles of the invention.

What is claimed is:

1. An electrical connector comprising:
an insulating housing comprising a longitudinal and a lateral wall defining a top face, the lateral wall defining a slot thereon;
at least one contact, each comprising a main body located one the top face of the lateral wall and a contacting arm located above the top of the longitudinal wall, a connecting portion extending from an inner edge of the main body and a retaining portion extending from an outer edge of the main body, the retaining portion being retained and received in the slot; and
a pressed portion laterally extending from the main body.

2. The electrical connector as described in claim 1, wherein the pressed portion comprises a first and second pressed portions respectively projecting from an outer and inner lateral edge of the retaining portion.

3. The electrical connector as described in claim 2, wherein tops of the first and second pressed portions are on a same lever while a bottom of the first pressed portion is higher than that of the second pressed portion.

4. The electrical connector as described in claim 3, wherein the lateral wall defines a passage going through the top face thereof.

5. The electrical connector as described in claim 1, wherein an abutting portion extends from the main body against a step portion on another longitudinal wall parallel to said longitudinal wall.

6. An electrical connector comprising:
an insulative housing defining a contact locating area;
a retaining slot downwardly in a vertical direction formed in the housing in said contacting locating area; and
a conductive contact including a main body with a contacting arm extending on one side, and a retention portion downwardly extending from another side of the main body via a curved transition section; wherein
said retention portion is a tab being wider than the transition section and having on two lateral side edges a pair of barbs to interfere within the slot, and a pair of pressing portions located above said pair of barbs and adjacent to the transition section under a condition that said pair of pressing portions face upward to allow a tool to abut thereagainst for evenly and stably pressing the tab downwardly into the slot.

7. The electrical connector as claimed in claim 6, further including a connecting portion opposite to the retention portion so as to cooperate with the retention portion to sandwich the housing therebetween in a horizontal direction perpendicular to said vertical direction.
